(19) United States
(12) Patent Application Publication
(10) Pub. No.: US 2008/0192774 A1
(43) Pub. Date: Aug. 14, 2008

(54) Method and system for aggregating multiple small packets in wireless communication

(75) Inventors: Harkirat Singh, Santa Clara, CA (US); Huaning Niu, Sunnyvale, CA (US); Chiu Ngo, San Francisco, CA (US)

Correspondence Address: Kenneth L. Sherman, Esq.;Myers Dawes Andras & Sherman, LLP, 11th Floor, 19900 MacArthur Blvd., Irvine, CA, 92612, US

(73) Assignee: Samsung Electronics Co., Ltd., Suwon City (KR)

(21) Appl. No.: 11/706,457

(22) Filed: Feb. 13, 2007

(51) Int. Cl. H04J 3/24

(52) U.S. Cl. 370/473

(57) ABSTRACT

A method and system for packet communication in a wireless system, implementing a process for aggregating multiple data units into a single aggregated frame, transported as payload in a carrier frame having a header, and separately protecting said header and payload with error recovery information for transmission over a wireless channel. The process further includes transmitting the carrier frame from a sender to a receiver over a wireless channel, using the error recovery information to detect if a data unit in the payload was received in error, and informing the sender to selectively retransmit a correct copy of the data unit received in error.

### FIELD OF THE INVENTION

The present invention relates generally to wireless communication systems and in particular, to aggregating multiple small packets in wireless communication.

### BACKGROUND OF THE INVENTION

In many wireless communication systems including one or more transmitters and one or more receivers, a frame structure is used for data transmission between a transmitter and a receiver. For example, the IEEE 802.11 standard uses frame aggregation in a Media Access Control (MAC) layer and a physical (PHY) layer.

In a typical wireless transmitter, a MAC layer receives a MAC Service Data Unit (MSDU) and attaches a MAC header thereto, in order to construct a MAC Protocol Data Unit (MPDU). The MAC header includes information such as a source address (SA) and a destination address (DA). The MPDU is a part of a PHY Service Data Unit (PSDU) and is transferred to a PHY layer in the transmitter to attach a PHY header (i.e., a PHY preamble) thereto to construct a PHY Protocol Data Unit (PPDU). The PHY header includes parameters for determining a transmission scheme including a coding/modulation scheme.

The IEEE 802.11 Task Group n (TGn) provides a high data rate wireless local area network (WLAN) standard (the IEEE 802.11n) which allows a maximum throughput of at least 100 Mbps (at the MAC layer). It has been observed that when the frame/packet sizes are smaller, the PHY overhead consumes a significant amount of channel time. One solution is to increase the payload to reduce the PHY overhead. One TGn specification (IEEE P802.11n/D1.0 (March 2006), “Amendment: Wireless LAN MAC and PHY specifications: Enhancement for Higher Throughputs”), incorporated herein by reference) provides two types of aggregation schemes, Aggregated MSDU (A-MSDU) and Aggregated MPDU (A-MPDU), for communication between a wireless sender (a data transmitter) and a wireless receiver (a data receiver).

FIG. 1 shows the structure of a MPDU 10 including an A-MSDU 12 as a payload. The A-MSDU 12 includes multiple MSDUs 14 joined together to create a single larger MSDU that is transported in the MPDU 10. Thus, the A-MSDU 12 aggregates the multiple MSDUs 14 for transmission of a receiver in a single MPDU 10. This improves the efficiency of the MAC layer, particularly when there are many small MSDUs 14, such as VoIP packets or TCP acknowledgements. The A-MSDU 12 includes a sequence of n MSDU subframes. Each subframe comprises a subframe header followed by a MSDU and 0-3 bytes of padding. A subframe (except the last) is padded so that its length is a multiple of 4 bytes. The last subframe has no padding.

Further, as shown in FIG. 1, the Frame Check Sequence (FCS) field 16 is used to protect both the MAC header 18 and the payload (i.e., the A-MSDU frame). The MAC header 18 is not protected separately. Therefore, whenever a corrupted frame is received, the FCS field 16 cannot indicate whether the error has occurred on the A-MSDU 12 or the MAC header 18. The FCS field 16 cannot localize the error.

In a WLAN, packet transmission is affected by frequent channel errors. In IEEE 802.11 type WLANS, to address frequent packet errors a receiver sends an acknowledgement (ACK) for each successful packet received. Specifically, after receiving an MPDU packet 20 (FIG. 2) the receiver checks the integrity of the packet by computing CRC (cyclic redundancy checksum) of the packet and compares it against the 4 byte FCS stored in the packet by the sender (transmitter). Since FCS is used for error recovery only, even a single bit error will cause the receiver to discard the packet 10. Moreover, as noted, the receiver cannot determine if the error occurred in the header or in the payload. As such, the entire packet must be retransmitted by the sender. Therefore, there is a need for efficient transmission and retransmission of data in wireless packet transmission.

### BRIEF SUMMARY OF THE INVENTION

The present invention provides a method and system for packet communication in a wireless system, implementing a process including the steps of aggregating multiple data units into a single aggregated frame transported as a payload in a carrier frame having a header and separately protecting said header and payload with error recovery information for transmission over a wireless channel. The process further includes the steps of transmitting the carrier frame from a sender to a receiver over a wireless channel, using the error recovery information to detect if a data unit in the payload was received in error, and informing the sender to selectively retransmit a correct copy of the data unit received in error.

The step of informing the sender further includes generating a block acknowledgment (BA) for the data units in the payload, wherein the BA identifies each data unit received in error and transmitting the BA from the receiver to the sender. Upon receiving the BA, the sender selectively retransmits a correct copy of each data unit identified in the BA as received in error, thereby avoiding retransmission of correctly received data units. In one case, each data unit comprises a subframe including a MSDU, the aggregated frame comprises an A-MSDU, and the carrier frame comprises a MPDU.

These and other features, aspects and advantages of the present invention will become understood with reference to the following description, appended claims and accompanying figures.

### BRIEF DESCRIPTION OF THE DRAWINGS

FIG. 1 shows a conventional A-MSDU data format.

FIG. 2 shows a conventional data MPDU frame format.

FIG. 3 shows a conventional MPEG-2 System Architecture.

FIG. 4 shows a conventional Transport Packet (TS) layout.

FIG. 5 shows a MPDU data format for a TS packet aggregation (TSPA) process, according to an embodiment of the present invention.

FIG. 6A shows an example format for the FCS field in the MPDU of FIG. 5 for sender to signal TSPA to a receiver, according to an embodiment of the present invention.

FIG. 6B shows the format of the FCS field used in a block acknowledgment, according to an embodiment of the present invention.

FIG. 7 shows a flowchart of example steps implemented by a TSPA sender, according to an embodiment of the present invention.

FIG. 8 shows a BA MPDU for acknowledging a TSPA MPDU, according to an embodiment of the present invention.

FIG. 9A shows a flowchart of example steps implemented by a TSPA receiver, according to an embodiment of the present invention.

FIG. 9B shows a flowchart of example steps implemented by a TSPA receiver for generation of a BA MPDU, according to an embodiment of the present invention.

FIG. 10A shows an example format for FCS field of a TSPA MPDU for signaling TSPA to a receiver, according to an embodiment of the present invention.

FIG. 10B shows an example format of the FCS field of a BA MPDU, according to an embodiment of the present invention.

FIG. 11 shows a flowchart of example steps implemented by a TSPA sender, according to another embodiment of the present invention.

FIG. 12 shows a flowchart of example steps implemented by a TSPA receiver, according to another embodiment of the present invention.

FIG. 13 shows another MPDU data format for a TSPA process, according to an embodiment of the present invention.

FIG. 14 shows a functional block diagram of a wireless system implementing aggregation of multiple small packets, according to an embodiment of the present invention.

### DETAILED DESCRIPTION OF THE INVENTION

The present invention provides a method and a system for aggregating multiple small MSDUs into one A-MSDU that is transported in a MPDU, for high throughput at the MAC layer and transmission robustness.

Further, the MAC header and payload (A-MSDU) of a MPDU frame are separately protected with error recovery information for transmission from a sender (transmitter). As such, a receiver can detect whether the error is in the MAC header or in the payload (A-MSDU). Further, the receiver utilizes a block acknowledgment which allows the sender to selectively retransmit erroneous MSDUs, without requiring any changes in the standard frames.

An example implementation of the present invention for aggregating small MSDUs containing TS packets of MPEG-2 stream in a WLAN is now described.

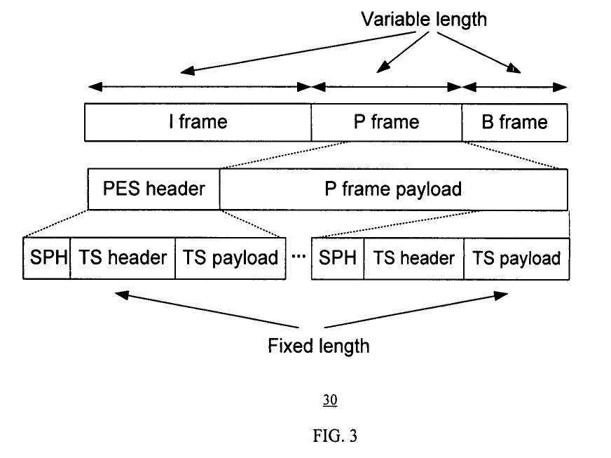

The output of a MPEG-2 video/audio encoder is an elementary stream. This elementary stream is usually organized into access units, which is a picture frame in the case of a video stream. Referring to the conventional MPEG-2 frame architecture 30 in FIG. 3, there are different kinds of picture frames: I (Interpolative), B (Bi-directional), and P (Predictive) frame. The elementary stream is mapped into a packetized elementary stream (PES). The I, B and P frames are of different sizes; therefore, each PES packet has a variable size payload. Each PES packet is then converted into fixed size TS packets.

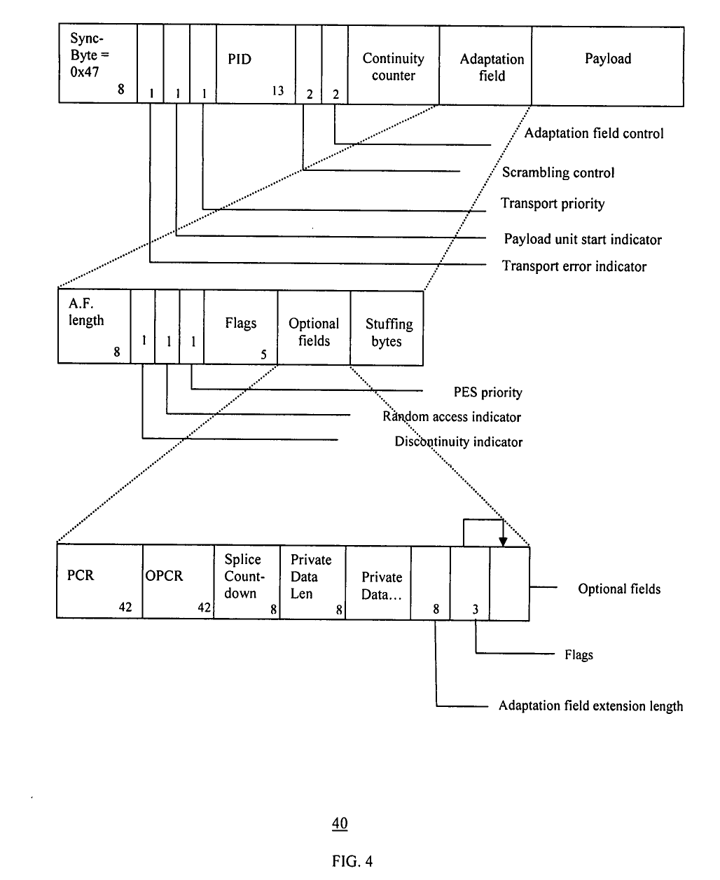

FIG. 4 shows the layout of a conventional MPEG-2 TS packet 40. The first four bytes represent a unique sync-byte (header). A packet identifier (PID) determines the program to which the TS packet belongs to. The PID is unique for each program. A transport error indicator (TEI) can be used to notify the decoder in the receiver about possible errors so that error concealment techniques can be employed. A transport priority field can be used to determine whether this TS packet has higher priority than other TS packets from the same program (i.e., the same PID). Such packets would typically belong to the base layer of scalable MPEG-2 streams. A program clock reference (PCR) is contained in the adaptation field control and provides a timing reference for the decoder for synchronization. The MPEG2-TS packet of IEC 61883-4 compliant isochronous data contains a 4 byte header called Source Packet Header (SPH) which contains a timestamp. The timestamp represents the intended delivery time of the first byte of the transport stream to the decoder. Thus, the total size of an MPEG2-TS packet is 192 bytes.

In this example implementation, the present invention provides a TSPA process using A-MSDU aggregation to join multiple TS packets to increase the effective MSDU size. To prevent any single bit error from causing a retransmission of the entire aggregated MPDU frame, both the MAC header and each subframe of the payload (A-MSDU) of a MPDU frame are separately protected. This allows retrieving free TS packets from the payload (A-MSDU), and selectively retransmitting a correct copy of erroneous TS packets by the sender.

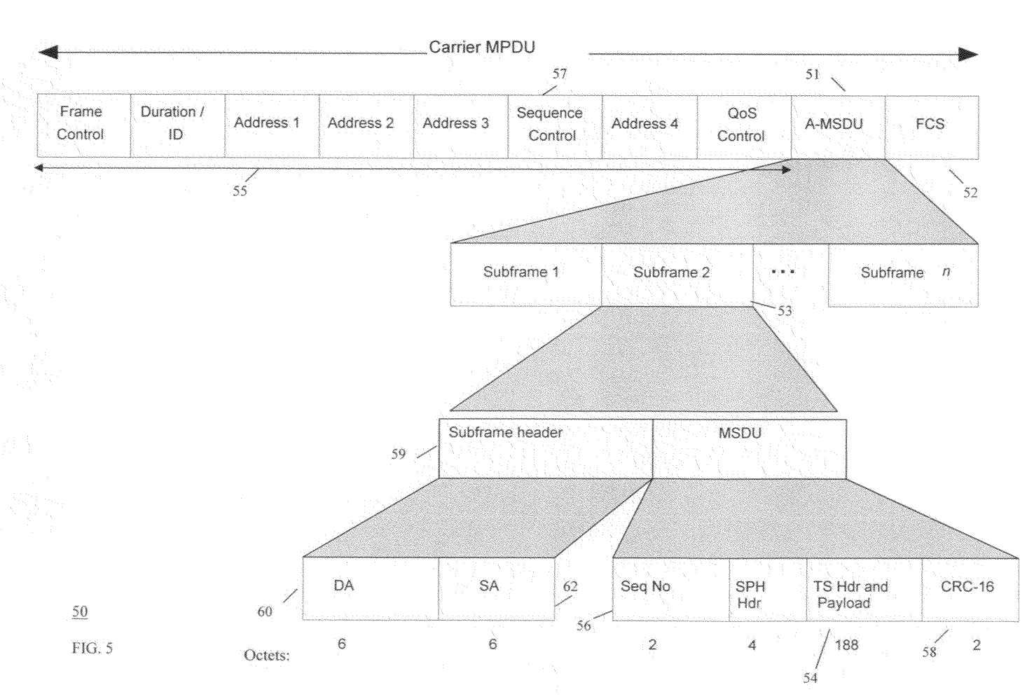

Referring to the example TSPA Format 50 shown in FIG. 5 according to the present invention, the A-MSDU frame 51 includes a FCS field 52 which is modified such that the sender computes a CRC-16 for the MPDU header 55, instead of computing a CRC-32 over the entire frame 50. The A-MSDU frame 51 includes multiple subframes 53. Each subframe 53 includes a single TS packet in a payload sub-field 54. In each subframe 53, the sender includes a 2-byte sequence number in a sub-field 56, and a CRC-16 in a 2-byte subframe checksum (SFCS) sub-field 58. For each subframe 53, the sender calculates a CRC-16 over that subframe and stores the CRC-16 in the SFCS sub-field 58. The CRC-16 described herein is the same one used in IEEE 802.11b-1999.

For each A-MSDU frame 53, the subframe sequence number monotonically increases starting from zero. Thus, the sequence number in the subfield 56 uniquely distinguishes a TS packet in a subframe 53 within the A-MSDU 51.

Each subframe 53 further includes a header 59. Since fixed length TS packets are used, the header 59 does not include a length field. The total size of each subframe 53 is 208 bytes (as shown in FIG. 5), which is word aligned (i.e., evenly divisible by 4). As such, there is no need for padding bytes in a subframe 53.

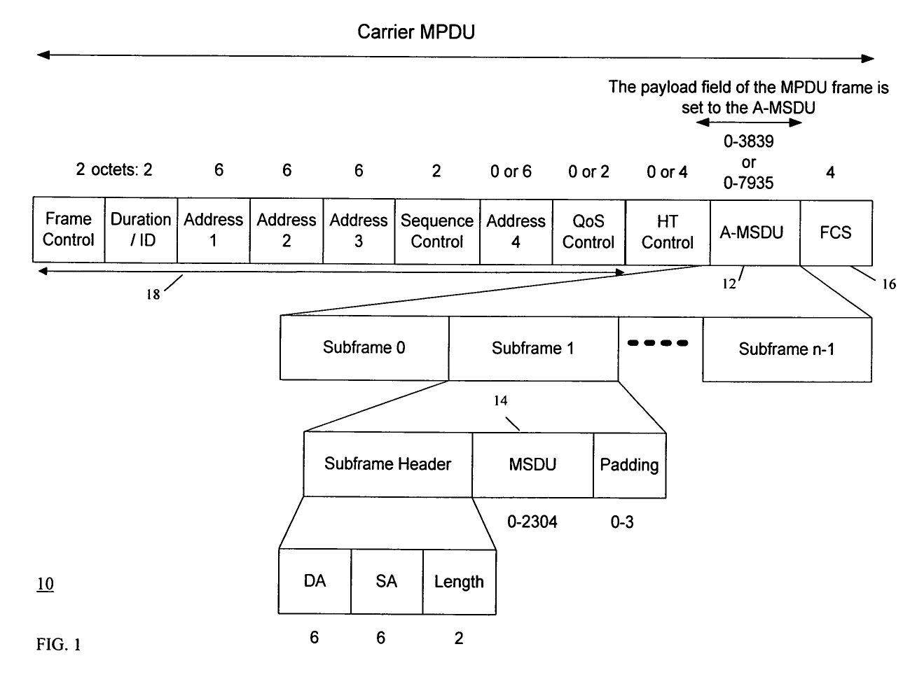

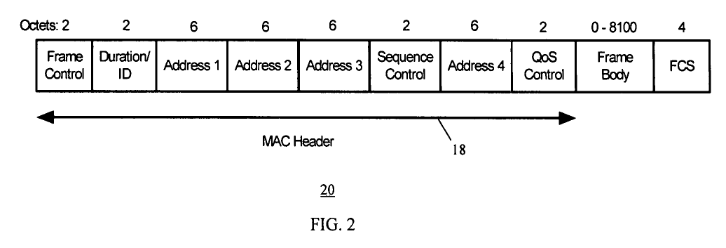

Since in the TSPA frame 50 the FCS field 52 provides a CRC-16 for the header 55 only, the subframes 53 and the header 55 are separately protected by corresponding CRC-16 fields for error correction. As such, the receiver can easily detect whether the error is in the header 55 or in a subframe 53 in the A-MSDU 51. This way, the receiver can localize bit errors and avoid loss of the entire MPDU 50 and all of the subframes 53. By contrast, in the conventional A-MSDU scheme (FIG. 1), any bit error is equivalent to the entire MPDU frame being corrupted.

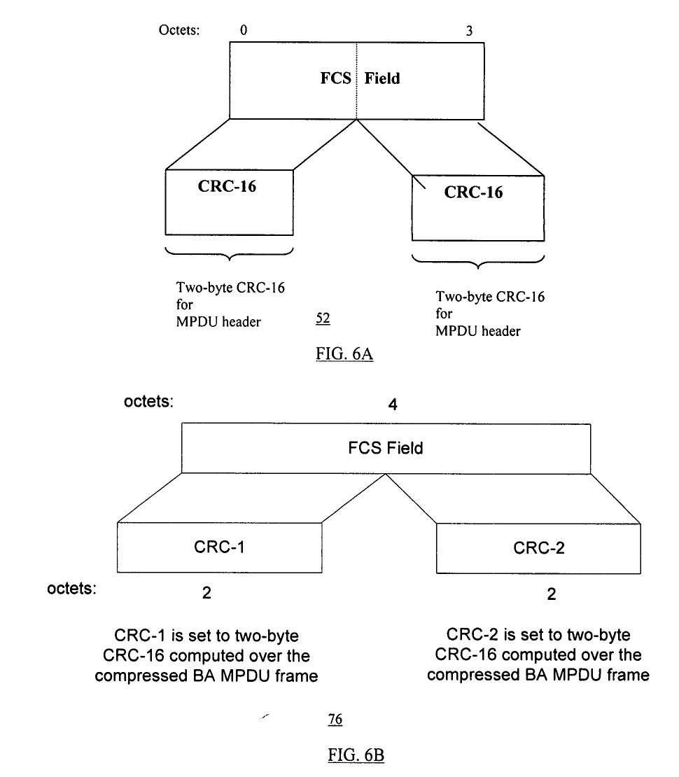

A sender of a TSPA frame 50, according to the present invention, fills the FCS field 52 with two CRC-16 values (i.e., CRC-1 and CRC-2) as shown in FIG. 6A, which are computed over the header 55. This signals the TSPA receiver to check the FCS field 52 for errors in the header 55 only.

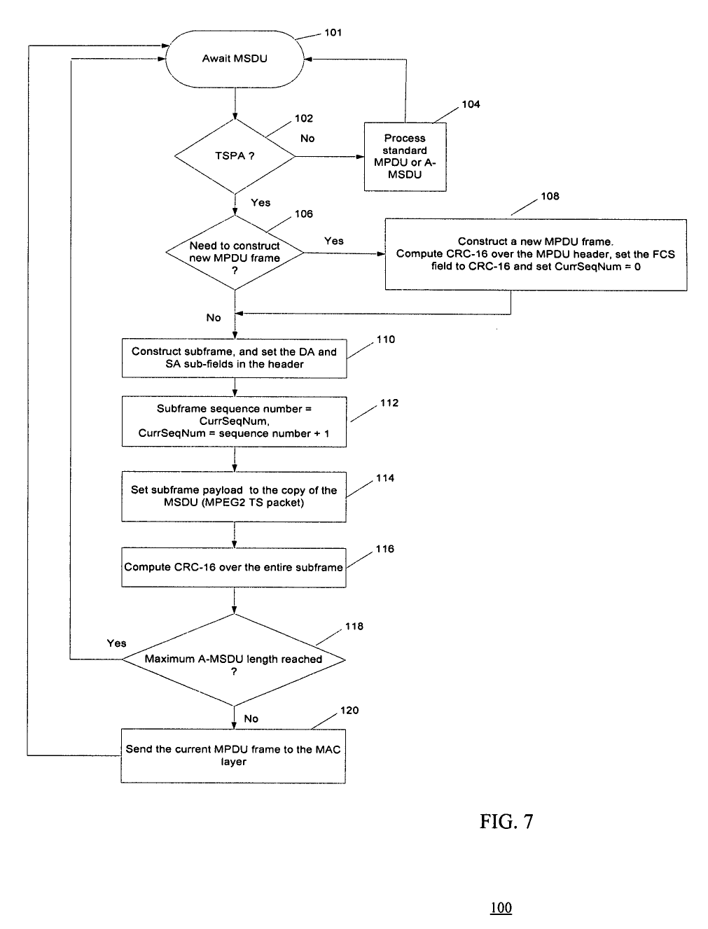

FIG. 7 shows a flowchart of a process 100 for generating and transmitting a TSPA frame (packet 50) from a wireless communication station (TSPA sender) in a WLAN that includes multiple wireless communication stations. The process 100 for a TSPA sender station includes the steps of:
Step 101: Await a MSDU including MPEG2 TS Packets from a higher layer for transmission over a wireless channel.
Step 102: Determine if the station is capable of processing TSPA packets (FIG. 5). If no, then proceed to step 104, otherwise proceed to step 106.
Step 104: Process standard MPDU or A-MSDU, go back to step 101.
Step 106: Determine if construction of a new MPDU TSPA frame 50 (FIG. 5) is required. If yes, go to step 108, otherwise go to step 110.
Step 108: Construct a new MPDU TSPA frame 50 (FIG. 5), compute CRC-16 of the MPDU header, and fill the FCS field 52 with CRC-1 and CRC-2 with CRC-16 (FIG. 6A). Initialize a CurrSeqNum variable, and proceed to step 110.
Step 110: Append the incoming MSDU to the MPDU 50. Construct subframe header 59 (FIG. 5), and populate destination address (DA) subfield 60 and source address (SA) subfield 62 of the subframe 53.
Step 112: Set the sequence number subfield 56 to CurrSeqNum. Increment CurrSeqNum by one for the next subframe.
Step 114: Set the subframe payload 54 to the copy of the MSDU (e.g., MPEG2 TS packet) received from a higher layer.
Step 116: Compute CRC-16 over the entire subframe 53 and store the CRC-16 in the SFCS subfield 58 (FIG. 5).
Step 118: Determine if the maximum A-MSDU length has been reached, or if it is possible to append another MSDU to the A-MSDU 51. If not, go to step 120, otherwise, proceed to step 101 to append another subframe (or a MSDU).
Step 120: Send the current MPDU frame 50 to the MAC layer for transmission to a TSPA receiver, and proceed to step 101.

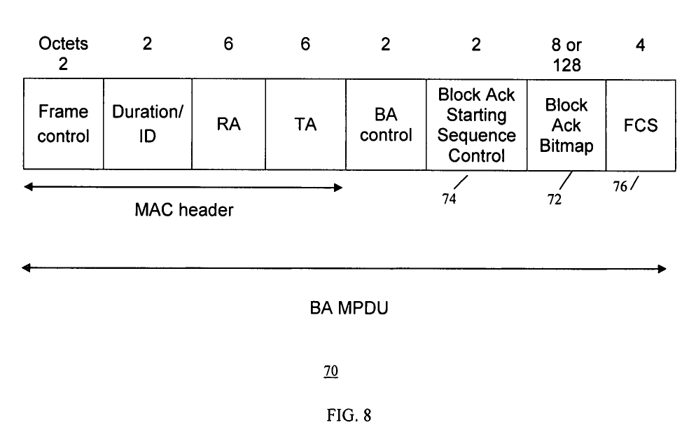

Upon receiving a MPDU 50, a TSPA receiver examines the MPDU for correctness using the CRC information therein. Based on the CRC information, the TSPA receiver constructs an acknowledgement comprising a block acknowledgment MPDU (BA MPDU) 70 as shown in FIG. 8. The TSPA receiver uses a Block Ack Bitmap field 72 in the BA MPDU 70 to indicate whether each TS packet in a subframe 53 of the received MPDU 50 was successfully received or not. The BA MPDU 70 is transmitted to the TSPA sender which uses the Block Ack Bitmap field 72 therein to selectively retransmit a correct copy of any erroneous TS packet.

A Block Ack Starting Sequence Control field 74 in the BA MPDU 70 is set using the sequence control field 57 in the received MPDU frame. As in the TSPA sender, the TSPA receiver uses a modified FCS field 76 in the BA MPDU 70 to indicate that the receiver is acknowledging the received TSPA MPDU (FIG. 5) including an A-MSDU as the payload. FIG. 6B shows an example of the FCS field 76, according to an embodiment of the present invention.

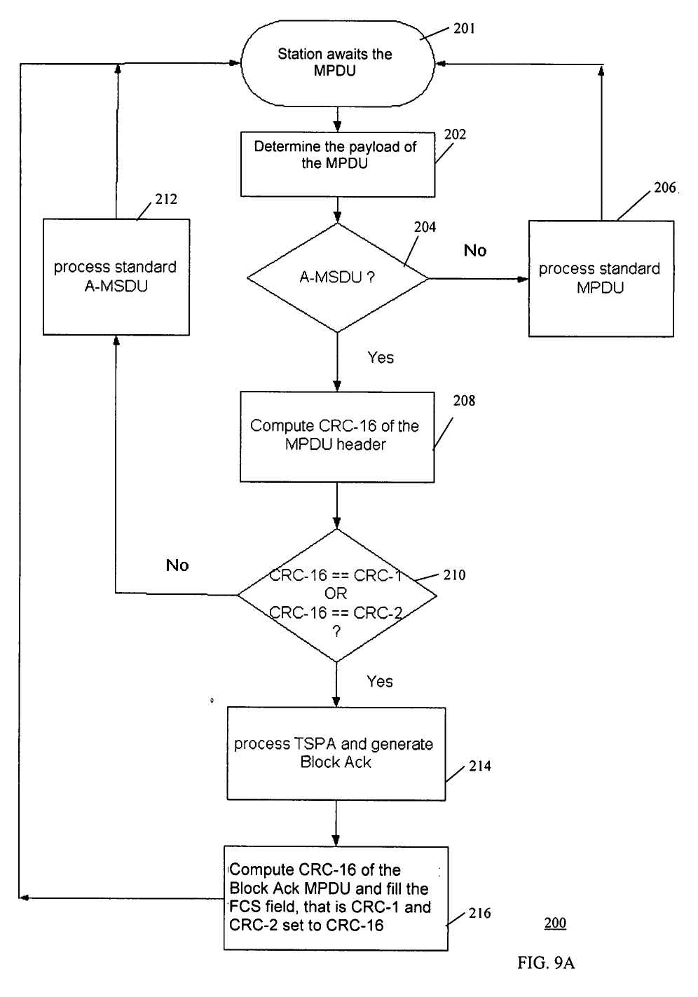

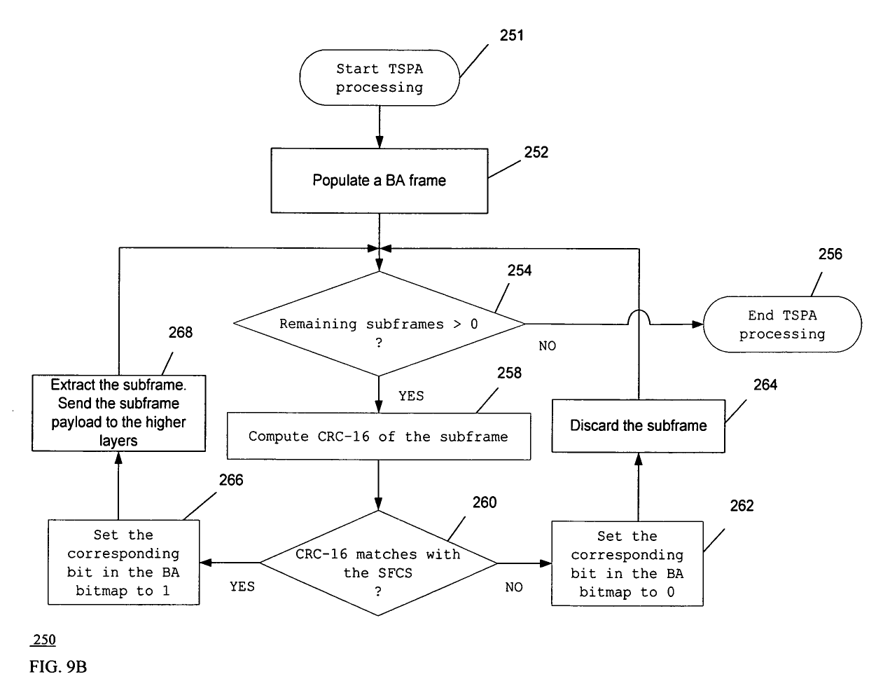

FIG. 9A shows a flowchart of an example process 200 implemented in the TSPA receiver station (AP or STA) for receiving a TSPA MPDU from the TSPA sender, including the steps of:
Step 201: Wait until the MPDU arrives.
Step 202: Determine the payload of the MPDU.
Step 204: If the MPDU payload is an A-MSDU then go to step 208 to process a MPDU, otherwise go to step 206 to process a standard MPDU.
Step 206: Process a standard MPDU, and proceed to step 201.
Step 208: Compute CRC-16 for the header of the MPDU.
Step 210: Determine if the computed CRC-16 matches the CRC-1OR CRC-2 in the FCS field of the MPDU.
Step 212: If neither of the cases in step 210 is true, then process the A-MSDU in the MPDU as a standard A-MSDU, and proceed to step 201.
Step 214: Otherwise, the MPDU is a TSPA MPDU 50 (FIG. 5). Perform error recovery for the subframes 53 of the A-MSDU 51 in the MPDU 50, and generate a BA MPDU 70 including a Block Ack bitmap 72 (FIG. 8) for transmission to the sender.
Step 216: Compute a CRC-16 for the BA MPDU 70 and fill the FCS field 76 (FIG. 6B) of the BA MPDU 70. Both the CRC-1 and CRC-2 fields of the FCS field 76 are set to CRC-16. Proceed to step 201.

In step 210 of FIG. 9A, if either the CRC-1 or CRC-2 mistakenly matches with CRC-16 of the MPDU header, then the TSPA receiver may mistake a standard (conventional) MPDU from a sender, for a TSPA MPDU 50 according to the present invention. In that case, the TSPA receiver responds with a BA MPDU 70, which the sender will reject as it is expecting a standard acknowledgment without a bitmap field 72. The sender will then recover by retransmitting the MPDU.

FIG. 9B shows a flowchart of an example process 250 implementing step 214 above in generating the BA MPDU 70, according to an embodiment of the present invention. The process 250 includes the steps of:
Step 251: Start TSPA processing to generate the BA MPDU 70 for the subframes 53 of the A-MSDU 51 in the received TSPA MPDU 50 (FIG. 5).
Step 252: Populate the header of the BA MPDU 70.
Step 254: Determine if there are any remaining subframes 53 in the A-MSDU frame 51. If yes, go to step 258, otherwise go to step 256.
Step 256: End TSPA processing and transmit BA MPDU 70 to the TSPA sender.
Step 258: Compute CRC-16 over the current subframe 53.
Step 260: Check if CRC-16 matches with the SFCS field 58 of the subframe 53. If a match, then go to step 266, otherwise go to step 262.
Step 262: Set the corresponding bit in the bitmap 72 of the BA MPDU 70 to 0 indicating error in receipt of the current subframe.
Step 264: Discard the subframe, and proceed to step 254 to process any remaining subframe 53 in the A-MSDU 51.
Step 266: Set the corresponding bit in the bitmap 72 of the BA MPDU 70 to 1 indicating successful receipt of the current subframe 53.
Step 268: Extract the subframe 53 from the A-MSDU 51, and provide the current subframe payload to the higher layers. Proceed to step 254 to process any remaining subframe 53 in the A-MSDU 51.

Upon receiving the BA MPDU 70 from the TSPA receiver, the TSPA sender uses the bitmap 72 in the BA MPDU 70 to selectively retransmit erroneous subframes in the next MPDU from the TSPA sender to the TSPA receiver. The receiver then uses the retransmitted subframe in place of the discarded subframes.

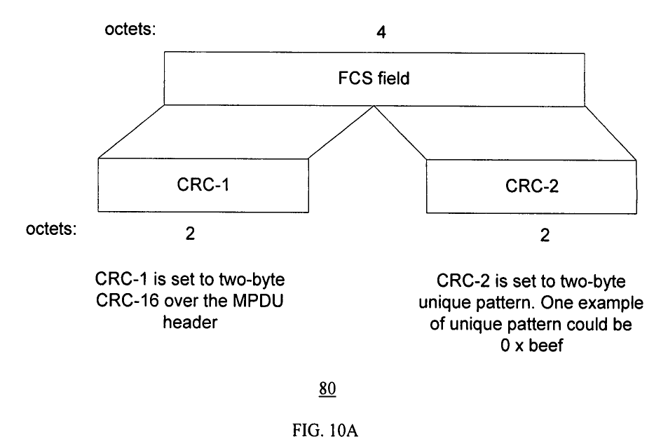

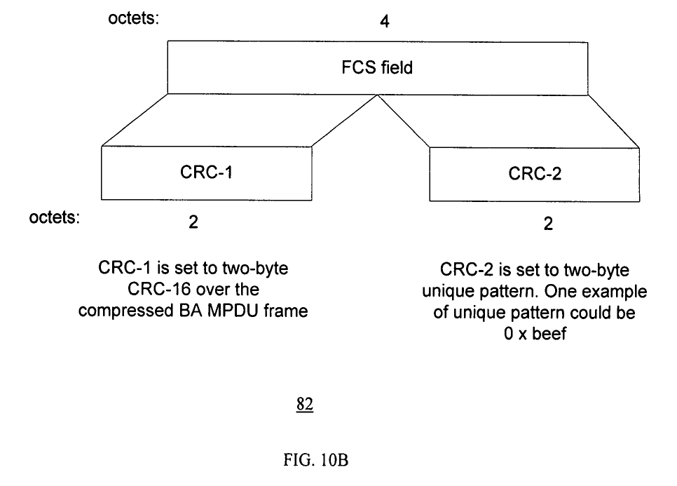

In the processes shown in FIGS. 7 and 9A, back-to-back CRC fields (CRC-1 and CRC-2) are used for TSPA detection and signaling. In an alternative TSPA process according to the present invention, one of the CRC-16 fields can be replaced with a unique pattern, as described by the following example. In this case, the TSPA sender fills the FCS field of the MPDU 50 with the alternate FCS format 80 shown in FIG. 10A. The TSPA receiver uses the same BA MPDU 70 of FIG. 8; however, it replaces the FCS field 76 with the alternate FCS field 82 shown in FIG. 10B. In one example, said unique pattern can be set to the hexadecimal value 0xBEEF, or it can be any 2-byte pattern mutually agreed upon between the sender and receiver. Using a two-byte unique pattern in the FCS field 80 (FIG. 10A), the TSPA sender signals to the TSPA receiver to compute CRC-16 only for the header 55 of the MPDU 60. A receiver not understanding this format will generate a FCS error.

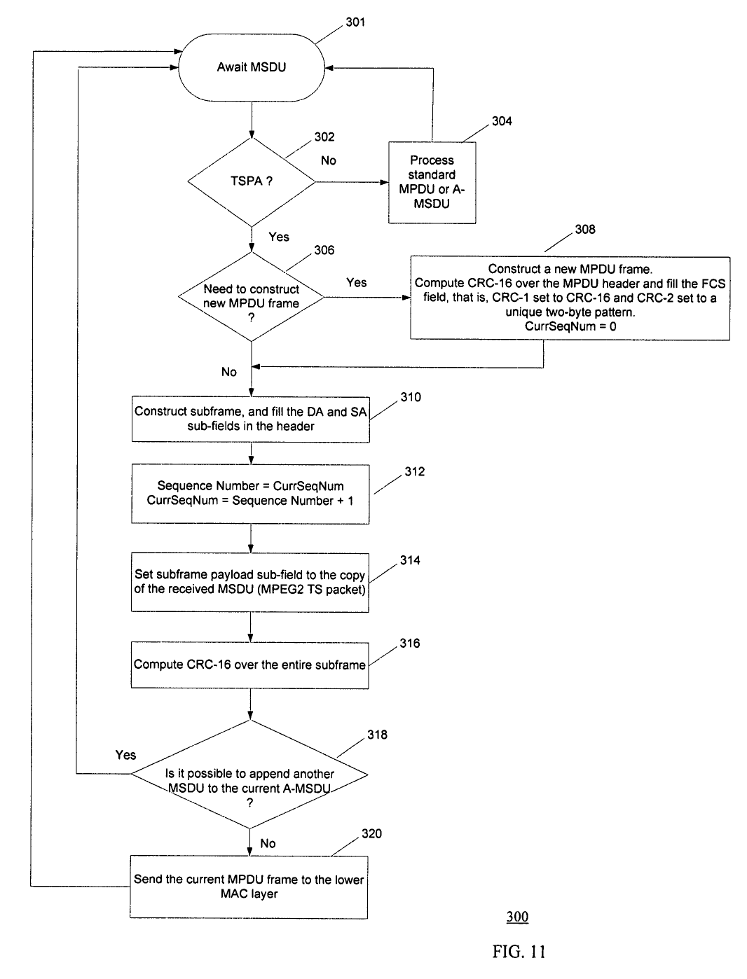

FIG. 11 shows a flowchart of an implementation of the alternative TSPA process 300 in a TSPA sender according to the present invention, including the steps of:
Step 301: Await a MSDU including MPEG2 TS packets from a higher layer for transmission over a wireless channel.
Step 302: Determine if the station is capable of processing TSPA packets (FIG. 5). If no, then proceed to step 304, otherwise proceed to step 306.
Step 304: Process standard MPDU or A-MSDU, go back to step 301.
Step 306: Determine if construction of a new MPDU TSPA frame 50 (FIG. 5) is required. If yes, go to step 308, otherwise go to step 310.
Step 308: Construct a new MPDU TSPA frame 50, compute CRC-16 of the MPDU header, and fill the FCS field 80 such that the CRC-1 field is set to CRC-16 and CRC-2 fields is set to a unique pattern. Initialize a CurrSeqNum variable, and proceed to step 310.
Step 310: Append the incoming MSDU to the MPDU 50. Construct subframe header 59, and populate DA subfield 60 and SA subfield 62 of the subframe 53.
Step 312: Set the sequence number subfield 56 to CurrSeqNum. Increment CurrSeqNum by one for the next subframe.
Step 314: Set the subframe payload 54 to the copy of the MSDU (e.g., MPEG2 TS packet) received from a higher layer.
Step 316: Compute CRC-16 over the entire subframe 53 and store the CRC-16 in the SFCS field 58.
Step 318: Determine if maximum A-MSDU length has been reached, or if it is possible to append another MSDU to the A-MSDU 51. If not, go to step 320, otherwise, proceed to step 301 to append another subframe (or MSDU).
Step 320: Send the current MPDU frame 50 to the MAC layer for transmission to a TSPA receiver, and proceed to step 301.

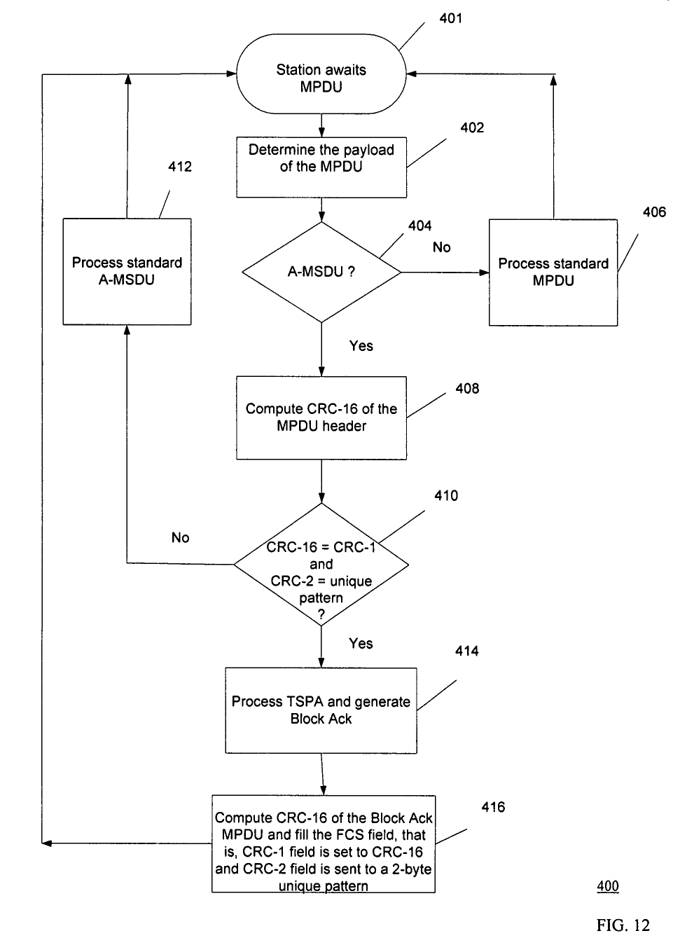

FIG. 12 shows a flowchart of an example process 400 implemented in an alternative TSPA receiver station for receiving a TSPA MPDU from the alternative TSPA sender, including the steps of:
Step 401: Wait until the MPDU arrives.
Step 402: Determine the payload of the MPDU.
Step 404: If the MPDU payload is an A-MSDU then go to step 408 to process a MPDU, otherwise go to step 406 to process a standard MPDU.
Step 406: Process a standard MPDU, and proceed to step 401.
Step 408: Compute CRC-16 for the header of the MPDU.
Step 410: Determine if the computed CRC-16 matches the CRC-1 and 2-byte unique pattern matches with the CRC-2 field.
Step 412: If not, then process the A-MSDU in the MPDU as a standard A-MSDU, and proceed to step 401.
Step 414: Otherwise, the MPDU is a TSPA MPDU. Perform error recovery for the subframes 53 of the A-MSDU 51 in the TSPA MPDU, and generate a BA MPDU 70 including a Block Ack bitmap 72 (FIG. 8) for transmission to the sender.
Step 416: Compute a CRC-16 for the BA MPDU 70 and fill the FCS field 76 of the BA MPDU 70 as in the field format 82 by setting the CRC-1 field to CRC-16 and set the CRC-2 field to a 2-byte unique pattern. Proceed to step 401.

It is possible that in some cases the receiver mistakes a standard MPDU with a TSPA MPDU. A few such cases are as follows:
1. The FCS field falsely computes correct FCS for the header (i.e., CRC-16 over the MPDU header) correctly matches with the CRC-1 field. However, the unique pattern, as shown in FIG. 10A, can protect against this case.
2. The FCS field falsely computes correct FCS for the header and the unique pattern also matches. Either the DA field will not match with the receiver's address or subframes will not decode properly. The sender will resort to retransmission of the frame.
3. The FCS field (i.e., the CRC-1 and CRC-2 fields, FIG. 10A), and all of the subframes (FIG. 5) result in false positives. The receiver will reply with a BA MPDU 70, which the sender will reject as it is expecting a standard acknowledge. Again, the sender will retransmit the frame.

Therefore, in the worst case, the penalty is the retransmission of single MPDU. A benefit of the alternative TSPA process is that it requires less CRC computation, and can be easily detected based on the unique pattern.

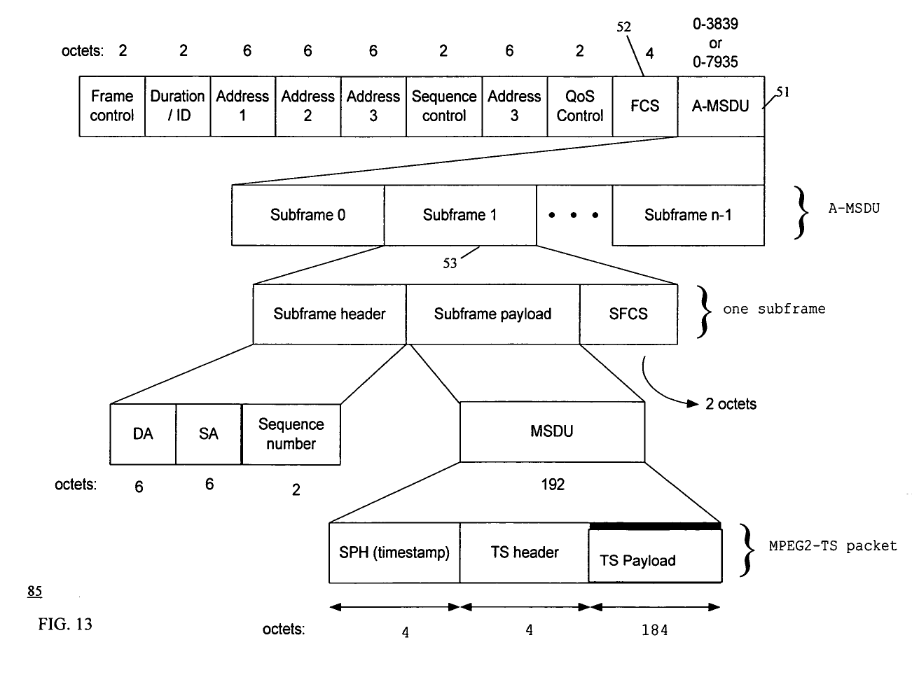

Another alternative involves moving the FCS field next to the MAC header, i.e., switching the A-MSDU and the FCS in the TSPA MPDU 85 as shown in FIG. 13. Because the FCS contains a CRC-16 checksum for the MAC header only, the CRC-16 checksum can be performed for the MAC header, right after decoding. If the CRC-16 checksum is correct and the FCS includes said unique pattern (FIGS. 10A-B), then a TSPA packet 85 is recognized by the receiver. If the CRC-16 checksum is incorrect and the FCS does not have the unique pattern (FIGS. 10A-B), then the received MPDU packet is processed as a standard A-MSDU in the receiver. The packet will be retransmitted due to the MAC header failure.

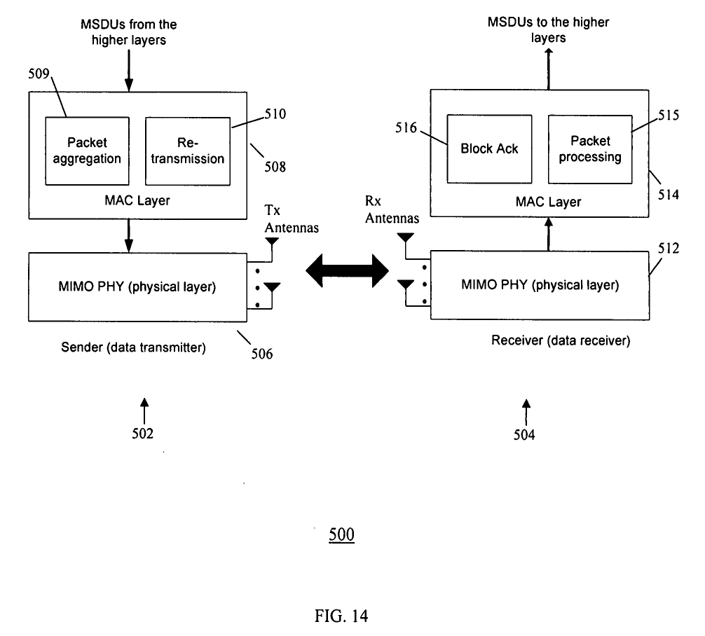

FIG. 14 shows a functional block diagram of an example wireless system 500 implementing the above methods of aggregating multiple small packets in a single A-MSDU, such as in a IEEE 802.11n system, according to an embodiment of the present invention. The system 500 includes a sender (TX) 502 and a receiver (RX) 504.

The sender 502 includes a Multiple-Input-Multiple-Output (MIMO) PHY layer 506 and a MAC layer 508. The MAC layer 508 includes a packet aggregation module 509 and a retransmission module 510. The receiver 504 includes a MIMO PHY layer 512 and a MAC layer 514. The MAC layer 514 includes a packet processing module 515 and a Block Ack module 516.

In this example, the PHY layers 506 and 512 implement the IEEE 802.11n standard specified MIMO PHY. The packet aggregation module 509 implements the processes in FIG. 7 or FIG. 11. The packet processing module 515 implements the processes in FIG. 9A or 12. The Block Ack module 516 performs the process in FIG. 9B. The retransmission module 510 of the sender retransmits subframes received in error based on block acknowledge bitmaps from the receiver, as described above.

The present invention further provides application of: separate FECs for the header and payload (as is done with CRC), or one common FEC for both the header and the payload, or a FEC for the header only (since FEC needs extra bits and requires extra bandwidth), etc. As such, separately protecting the header and payload can further include the step of: (1) providing separate FECs for the header and payload, (2) providing a FEC for both the header and payload, (3) providing a FEC for the header only, etc.

As is known to those skilled in the art, the aforementioned example architectures described above, according to the present invention, can be implemented in many ways, such as program instructions for execution by a processor, as logic circuits, as an application specific integrated circuit, as firmware, etc.

The present invention has been described in considerable detail with reference to certain preferred versions thereof; however, other versions are possible. Therefore, the spirit and scope of the appended claims should not be limited to the description of the preferred versions contained herein.

What is claimed is:

1. A method of packet communication in a wireless system, comprising the steps of:
aggregating multiple data units into a single aggregated frame transported as payload in a carrier frame having a header; and
separately protecting said header and a payload with error detection information for transmission over a wireless channel.

2. The method of claim 1 further comprising the steps of:
transmitting the carrier frame from a sender to a receiver over a wireless channel;
using the error detection information to detect if a data unit in the payload was received in error; and
informing the sender to selectively retransmit a correct copy of the data unit received in error.

3. The method of claim 2 wherein the step of informing the sender includes:
generating a block acknowledgment (BA) for the data units in the payload, wherein the BA identifies each data unit received in error; and
transmitting the BA from the receiver to the sender.

4. The method of claim 3 further comprising the step of:
the sender selectively retransmitting a correct copy of each data unit identified in the BA as received in error, thereby avoiding retransmission of correctly received data units.

5. The method of claim 2 wherein:
each data unit comprises a subframe including a MSDU;
the aggregated frame comprises an A-MSDU; and
the carrier frame comprises a MPDU.

6. The method of claim 5 wherein:
the step of informing the sender includes generating a BA that includes a plurality of acknowledgment bits corresponding to a plurality of MSDUs in a received A-MSDU;
the method further includes the steps of:
transmitting the block acknowledgment to the sender; and
selectively retransmitting from the sender each MSDU that requires retransmission as indicated by the corresponding acknowledgment bits in the BA.

7. The method of claim 6 wherein the BA further comprises a BA bitmap field that includes said plurality of acknowledgment bits.

8. The method of claim 6 wherein the step of generating the BA further includes the steps of:
generating a BA MPDU which comprises: (i) a bitmap field that indicates if each MSDU was successfully received or not, and (ii) an FCS field including a CRC-1 field and a CRC-2 field;
computing a CRC-16 for the BA MPDU; and
setting the CRC-1 and CRC-2 fields of the FCS field of the BA MPDU to the computed CRC-16.

9. The method of claim 8 wherein:
the CRC-1 comprises 2 octets set to a two-byte CRC-16 computed over the BA MPDU header; and
the CRC-2 comprises 2 octets set to a two-byte unique pattern.

10. The method of claim 9, wherein said unique pattern comprises 0xBEEF.

11. The method of claim 8, wherein the two CRC values enable the sender to detect that the BA MPDU is correct, and that the receiver is responding to an aggregated frame.

12. The method of claim 5 wherein the A-MSDU includes a CRC subfield for each MSDU, the CRC subfield includes error recovery information for that MSDU, thereby allowing a receiver to check for successful receipt of that MSDU.

13. The method of claim 5 wherein the step of separately protecting the MPDU frame header and payload further includes modifying an FCS field of the MPDU such that the sender computes CRC-16 for the header only, instead of the entire MPDU frame.

14. The method of claim 13 further comprising the step of the sender computing CRC-16 for each MSDU and appending the computed CRC-16 to the MSDU.

15. The method of claim 14 further comprising the step of adding a sequence number field to each MSDU to uniquely distinguish that MSDU.

16. The method of claim 15 wherein each MSDU includes a TS packet.

17. The method of claim 16 wherein the TS packets comprise TS packets of a MPEG-2 stream for wireless transmission.

18. The method of claim 17 further comprising the step of using fixed length MSDUs.

19. The method of claim 18 wherein the wireless system implements a type of IEEE 802.11 protocol.

20. The method of claim 5 wherein the step of separately protecting further comprises using separate CRC information for the MPDU header and the subframes, where the CRC information is stored in fields in the MPDU to detect any error upon reception.

21. The method of claim 20 the step of separately protecting further comprises the steps of:
including an FCS field such that the A-MSDU follows the FCS field in the aggregated frame; and
determining a CRC-16 for each MPDU subframe and storing that CRC-16 in a CRC subfield in that subframe.

22. The method of claim 17 further comprising the steps of:
filling the FCS field of the MPDU with two CRC values which are computed over the MPDU header only; and
the receiver computing a CRC for the MPDU header and a CRC for each of the MSDUs.

23. The method of claim 22 wherein the said two CRC values comprise:
a CRC-1 comprising 2 octets set to a two-byte CRC-16 computed over the MPDU header; and
a CRC-2 comprising 2 octets set to a two-byte CRC-16 computed over the MPDU header.

24. The method of claim 22 wherein said two CRC values comprise:
a CRC-1 comprising 2 octets set to a two-byte CRC-16 computed over the MPDU header; and
a CRC-2 comprising 2 octets set to a two-byte unique pattern.

25. The method of claim 20, wherein said unique pattern comprises 0xBEEF.

26. The method of claim 1 wherein the step of separately protecting said header and payload further includes the step of providing separate FECs for the header and payload.

27. The method of claim 1 wherein the step of separately protecting said header and payload further includes the step of providing an FEC for both the header and payload.

28. The method of claim 1 wherein the step of separately protecting said header and payload further includes the step of providing an FEC for the header only.

29. A wireless communication system comprising:
a wireless transmitter that includes:
an aggregation module that is configured to aggregate multiple data units into a single aggregated frame transported as payload in a carrier frame having a header; and
a protection module that is configured to separately protect said header and payload with error detection information for transmission over a wireless channel;
a wireless receiver that includes:
a receiving module that is configured to receive a carrier frame comprising a data payload and error detection information, from the transmitter over a wireless channel; and
an error detection module that is configured to use the received error recovery information to detect if a data unit in the payload was received in error, and inform the transmitter to selectively retransmit a correct copy of the data unit received in error.

30. The system of claim 29 wherein:
the aggregation module of the transmitter is further configured to aggregate a sequence of MSDUs into subframes of an A-MSDU transported as payload in an MPDU having a header; and
the protection module of the transmitter is further configured to separately protect said header and payload with error detection information for transmission over a wireless channel;
the transmitter further includes a retransmission module that is configured to selectively retransmit each MSDU that requires retransmission as indicated by a corresponding block acknowledgment from the receiver; and
the error recovery module of the receiver includes a MPDU processing module that is configured to evaluate the MPDU header and each of the MSDUs in a received A-MSDU for correctness; and
the error recovery module of the receiver further includes an acknowledgment module that is configured to generate a BA that includes a plurality of acknowledgment bits corresponding to a plurality of MSDUs in the received A-MSDU, for transmission to the transmitter.

31. The system of claim 30 wherein the BA further comprises a BA bitmap field that includes said plurality of acknowledgment bits.

32. The system of claim 31 wherein the BA comprises an MPDU which includes:
a bitmap field comprising a bit for each MSDU to indicate to the transmitter whether the corresponding MSDU was successfully received or not; and
an FCS field including a CRC-1 field and a CRC-2 field, each containing a CRC-16 computed over the BA MPDU.

33. The system of claim 25 wherein:
the CRC-1 comprises 2 octets set to a two-byte CRC-16 computed over the BA MPDU header; and
the CRC-2 comprises 2 octets set to a two-byte unique pattern.

34. The system of claim 30, wherein said unique pattern comprises 0xBEEF.

35. The system of claim 25, wherein the two CRC values enable the transmitter to detect that the BA MPDU is correct, and that the receiver is responding to an aggregated frame.

36. The system of claim 30 wherein the A-MSDU includes a CRC subfield for each MSDU, the CRC subfield including error detection information for that MSDU, thereby allowing a receiver to check for successful receipt of that MSDU.

37. The system of claim 30 wherein the aggregation module is further configured to modify the FCS field of the MPDU to include a CRC-16 computed for the MPDU header only, instead of the entire MPDU frame.

38. The system of claim 37 wherein the aggregation module is further configured to compute a CRC-16 for each MSDU and append the computed CRC-16 to the MSDU.

39. The system of claim 38 wherein the aggregation module is further configured to add a sequence number field to each MSDU to uniquely distinguish that MSDU.

40. The system of claim 39 wherein each MSDU includes a TS packet.

41. The system of claim 40 wherein the TS packets comprise TS packets of a MPEG-2 stream for wireless transmission.

42. The system of claim 41 wherein each MSDU is of fixed size.

43. The system of claim 42 wherein the wireless system implements a type of IEEE 802.11 protocol.

44. The system of claim 30 wherein the aggregation module is further configured to use separate CRC information for the MPDU header and the subframes, and stores the CRC information in fields in the MPDU to detect any error upon reception.

45. The system of claim 44 wherein the aggregation module is further configured to determine a CRC-16 for each MPDU subframe and store that CRC-16 in a CRC subfield in that subframe.

46. The system of claim 45 wherein the aggregation module is further configured to fill the FCS field of the MPDU with two CRC values which are computed over the MPDU header only.

47. The system of claim 46 wherein the MPDU processing module of the receiver is further configured to:
compute a CRC for the MPDU header to determine header errors; and
compute a CRC for each MSDU to determine error in each MSDU.

48. The system of claim 45 wherein the said two CRC values comprise:
a CRC-1 comprising 2 octets set to a two-byte CRC-16 computed over the MPDU header; and
a CRC-2 comprising 2 octets set to a two-byte CRC-16 computed over the MPDU header.

49. The system of claim 45 wherein said two CRC values comprise:
a CRC-1 comprising 2 octets set to a two-byte CRC-16 computed over the MPDU header; and
a CRC-2 comprising 2 octets set to a two-byte unique pattern.

50. The system of claim 49, wherein said unique pattern comprises 0xBEEF.

51. A wireless transmitter comprising:
an aggregation module that is configured to aggregate multiple data units into a single aggregated frame transported as payload in a carrier frame having a header; and
a protection module that is configured to separately protect said header and payload with error detection information for transmission over a wireless channel.

52. The transmitter of claim 51 wherein:
the aggregation module is further configured to aggregate a sequence of MSDUs into subframes of an A-MSDU transported as payload in an MPDU having a header; and
the protection module is further configured to separately protect said header and payload with error detection information for transmission over a wireless channel to a wireless receiver; and
the transmitter further comprising a retransmission module that is configured to selectively retransmit each MSDU that requires retransmission as indicated by a corresponding block acknowledgment (BA) from the receiver.

53. The transmitter of claim 52 wherein the BA further comprises a BA bitmap field that includes said plurality of acknowledgment bits.

54. The transmitter of claim 53 wherein the BA comprises an MPDU which includes:
a bitmap field comprising a bit for each MSDU to indicate to the transmitter whether the corresponding MSDU was successfully received or not; and
an FCS field including a CRC-1 field and a CRC-2 field, each containing a CRC-16 computed over the BA MPDU.

55. The transmitter of claim 52 wherein the A-MSDU includes a CRC subfield for each MSDU, the CRC subfield including error recovery information for that MSDU, thereby allowing a receiver to check for successful receipt of that MSDU.

56. The transmitter of claim 52 wherein the aggregation module is further configured to modify the FCS field of the MPDU to include a CRC-16 computed for the MPDU header only, instead of the entire MPDU frame.

57. The transmitter of claim 56 wherein the aggregation module is further configured to compute a CRC-16 for each MSDU and append the computed CRC-16 to the MSDU.

58. The transmitter of claim 57 wherein the aggregation module is further configured to add a sequence number field to each MSDU to uniquely distinguish that MSDU.

59. The transmitter of claim 58 wherein each MSDU includes a TS packet.

60. The transmitter of claim 59 wherein the TS packets comprise TS packets of a MPEG-2 stream for wireless transmission.

61. The transmitter of claim 60 wherein each MSDU is of fixed size.

62. The transmitter of claim 61 wherein the transmitter implements a type of IEEE 802.11 protocol.

63. The transmitter of claim 52 wherein the aggregation module is further configured to use separate CRC information for the MPDU header and the subframes, and stores the CRC information in fields in the MPDU to detect any error upon reception.

64. The transmitter of claim 63 wherein the aggregation module is further configured to determine a CRC-16 for each MPDU subframe and store that CRC-16 in a CRC subfield in that subframe.

65. The transmitter of claim 64 wherein the aggregation module is further configured to fill the FCS field of the MPDU with two CRC values which are computed over the MPDU header only.

66. The transmitter of claim 65 wherein the said two CRC values comprise:
a CRC-1 comprising 2 octets set to a two-byte CRC-16 computed over the MPDU header; and
a CRC-2 comprising 2 octets set to a two-byte CRC-16 computed over the MPDU header.

67. The transmitter of claim 65 wherein said two CRC values comprise:
a CRC-1 comprising 2 octets set to a two-byte CRC-16 computed over the MPDU header; and
a CRC-2 comprising 2 octets set to a two-byte unique pattern.

68. The transmitter of claim 67, wherein said unique pattern comprises 0xBEEF.

69. A wireless receiver comprising:
a receiving module that is configured to receive a carrier frame comprising a data payload and error detection information over a wireless channel;
an error recovery module that is configured to use the received error detection information to detect if a data unit in the payload was received in error, and request selective retransmission of a correct copy of the data unit received in error.

70. The receiver of claim 69 wherein:
the receiving module is further configured to receive a MPDU over a wireless channel from a transmitter, the MPDU including an aggregated sequence of MSDUs in subframes of an A-MSDU forming the MPDU payload, the MPDU including a header, wherein said header and payload are separately protected with error detection information in the MPDU;
the error recovery module includes a MPDU processing module that is configured to evaluate the MPDU header and each of the MSDUs in a received A-MSDU for correctness; and
the error recovery module further includes an acknowledgment module that is configured to generate a BA that includes a plurality of acknowledgment bits corresponding to a plurality of MSDUs in the received A-MSDU, for transmission to the transmitter.

71. The receiver of claim 69 wherein the MPDU processing module is further configured to:
compute a CRC for the MPDU header to determine header errors; and
compute a CRC for each MSDU to determine error in each MSDU.

72. The receiver of claim 69 wherein the acknowledgment module is further configured to transmit the BA to the transmitter to allow the transmitter to selectively retransmit each MSDU that requires retransmission as indicated by a corresponding block acknowledgment from the receiver.

73. The receiver of claim 69 wherein the BA further comprises a BA bitmap field that includes said plurality of acknowledgment bits.

74. The receiver of claim 69 wherein the BA comprises an MPDU which includes:
a bitmap field comprising a bit for each MSDU to indicate to the transmitter whether the corresponding MSDU was successfully received or not; and
an FCS field including a CRC-1 field and a CRC-2 field, each containing a CRC-16 computed over the BA MPDU.

75. The receiver of claim 67 wherein:
the CRC-1 comprises 2 octets set to a two-byte CRC-16 computed over the BA MPDU header; and
the CRC-2 comprises 2 octets set to a two-byte unique pattern.

76. The receiver of claim 68, wherein said unique pattern comprises 0xBEEF.

77. The receiver of claim 67, wherein the two CRC values enable the transmitter to detect that the BA MPDU is correct, and that the receiver is responding to an aggregated frame.

78. The receiver of claim 69 wherein the A-MSDU includes a CRC subfield for each MSDU, the CRC subfield including error recovery information for that MSDU, thereby allowing a receiver to check for successful receipt of that MSDU.

79. The receiver of claim 69 wherein the received MPDU includes FCS field containing a CRC-16 value computed for the MPDU header only.

80. The receiver of claim 79 wherein the MPDU further include CRC error recovery information for each MSDU.

81. The receiver of claim 80 wherein each MSDU includes a sequence number to uniquely distinguish that MSDU.

82. The receiver of claim 81 wherein each MSDU includes a TS packet.

83. The receiver of claim 81 wherein the TS packets comprise TS packets of a MPEG-2 stream.

84. The receiver of claim 82 wherein each MSDU is of fixed size.

85. The receiver of claim 83 wherein the receiver implements a type of IEEE 802.11 protocol.

86. The receiver of claim 69 wherein the received MPDU includes separate CRC information for the MPDU header and the subframes, stored in fields in the MPDU to allow detecting errors in the header and individual MSDUs.

87. The receiver of claim 86 wherein the FCS field of the MPDU includes two CRC values which are computed over the MPDU header only.

88. The receiver of claim 87 wherein the said two CRC values comprise:
a CRC-1 comprising 2 octets set to a two-byte CRC-16 computed over the MPDU header; and
a CRC-2 comprising 2 octets set to a two-byte CRC-16 computed over the MPDU header.

89. The receiver of claim 87 wherein said two CRC values comprise:
a CRC-1 comprising 2 octets set to a two-byte CRC-16 computed over the MPDU header; and
a CRC-2 comprising 2 octets set to a two-byte unique pattern.

90. The receiver of claim 88, wherein said unique pattern comprises 0xBEEF.
